(19) United States
(12) Patent Application Publication
(10) Pub. No.: US 2007/0159605 A1
(43) Pub. Date: Jul. 12, 2007

(54) High efficiency scrolling colour display system

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,381

(22) PCT Filed: Nov. 30, 2004
(86) PCT No.: PCT/IB04/52609

§ 371 Date: Jun. 12, 2006

(30) Foreign Application Priority Data
Dec. 15, 2003 (EP) 03104696.4

(51) Int. Cl. G03B 21/00

(52) U.S. Cl. 353/31

(57) ABSTRACT

In the case of a food processor (1) having a base unit (2) and having a work container (40) that can be placed on a housing wall (3) of the base unit (2), and having a cover (47) for the work container (40), retaining means (55) for retaining both the work container (40) on the base unit (2) and the cover (47) on the work container (40) are provided, wherein the retaining device (55) comprises at least one retaining member (70, 71) provided on the inside of the cover (47) and a retaining member (57) provided on a shaft configuration (9) comprising a drive shaft (10).

### FIELD OF INVENTION

This invention relates to a high brightness scrolling colour display system. In particular, this invention relates to a liquid crystal colour projection system.

### BACKGROUND OF INVENTION

A scrolling colour projector, such as described in “Single Panel Reflective LCD Projectors”, by Volke Blume, in Displaytechnik, Fernseh- und Kino-Technich, no. 1-2/2002, produces full colour images from a single light modulator, such as a liquid crystal on silica (LcoS) panel, by illuminating the panel with multiple stripes of coloured light (red, green, blue) that continuously scroll, from top to bottom, over the liquid crystal panel.

American patent no. U.S. Pat. No. 6,540,362 discloses a scrolling colour projection system having an increased number of red, green and blue scrolling colour stripes achieved by a lenticular lens array and a second lens array for collimating the plurality of stripes. The collimated stripes are scrolled over the liquid crystal panel by using rotating prisms.

Further, American patent application no. US 2002/0191154 discloses a single panel colour liquid crystal display (LCD) projector, shown in FIG. 1a. The LCD projector system 100 utilising a scrolling colour system, wherein un-polarized light is split into constituent red, green and blue coloured light beams, and which LCD projection system 100 comprises a light source 102, colour separating means 104, a substantially non-absorptive polarizing element 106, a polarizing beam splitter 108, a light valve or modulator 110, and a projection lens 112. The light valve or modulator 110 is adapted to receive incident light and to impress a desired image upon the incident light, which image is then projected by the projection lens 112. The colour separating means 104 comprises dichroic colour filters 114, 116, 118 and 120, prisms 122, 124 and 126, and the reflecting mirrors 128 and 130. The colour separating means 104 generate scrolling and coloured light beams by rotating the prisms 122, 124 and 126.

The phase and rotation of the prisms 122, 124 and 126 are important, because each stripe of coloured light must be projected and scrolled on the light valve or modulator 110 at specific times in relation to video information (electrical scan) that is also provided to the light valve or modulator 110. That is, the red, green and blue stripes of light must be present on a line of the display concurrently with the presentation of the corresponding video information.

The American patent no. U.S. Pat. No. 6,540,362, the American patent application no. U.S. Pat. No. 2002/0191154 and the article entitled “Single Panel Reflective LCD Projectors”, which are hereby incorporated in the present specification by reference, describe scrolling colour projection systems utilising red, green and blue colour stripes. In these types of projection systems, the red, green and blue colour beams are scrolled geometrically separated over the display panel, and as such setting requirements on the display panel size to obtain an efficient filling of the light path with the light that originates from the light source. This can best been explained using the etendue principles within projection systems, such as described. in “Optimized light sources for projection displays”, by H. Mönch et al, in Society for Information Display international symposium may 18-20, 1999, Digest of technical papers, Volume XXX, pp 1076-1079, (SID 99 Digest). FIG. 1b shows the collectable lumen for a 100W, 1.0 mm arc UHP lamp as function of the etendue of the optical light path. On the x-axis the location of typical (3-panel based) projection systems are indicated for various panel sizes. Where in 3-panel projection systems the each individual panel is illuminated with one of the primary colours red, green and blue; in the scrolling colour projection systems these three coloured light areas are imaged on separated positions of one and the same panel. To obtain, however, the same amount of collected lumens from the light source, the total display area that is illuminated with light needs in the single panel system the same as in the 3-panel systems; meaning that a three 0.7″ panel projection system will use the same amount of collected lumens from the light source than a \sqrt{3}*0.7=1.2″ single panel scrolling colour projection system. Due to these etendue limitations of these prior art projection systems, single panel scrolling colour projection systems have the advantage that only 1 panel is required instead of 3, however at a \sqrt{3} etendue penalty, meaning that either a lower system efficiency needs to be accepted at similar display size, or a \sqrt{3} diagonal times larger panel needs to be applied to collect the same amount of lumens from the projection light source.

### SUMMARY OF THE INVENTION

It is an object of the present invention to provide a multiple primary scrolling colour system, which system increases usable etendue of a projection lamp without increasing the size of a display panel.

A particular advantage of the present invention is the provision of a system having expanded colour gamut.

This object is obtained according to a first aspect of the present invention having characterizing features as described in the characterizing part of claim 1.

Further embodiments are obtained according to the first aspect of the present invention as described in dependent claims 2-19.

### BRIEF DESCRIPTION OF THE DRAWING

The above, as well as additional objects, features and advantages of the present invention, will be better understood through the following illustrative and non-limiting detailed description of preferred embodiments of the present invention, with reference to the appended drawing, wherein:

FIG. 1a, shows a block diagram of a prior art projection system,

FIG. 1b, shows a graph of the collectable lumen for a 100W, 1.0 mm arc UHP lamp as function of the etendue of the optical light path,

FIG. 2, shows an illumination window according a prior art projection system,

FIG. 3, shows an illumination window according to a first embodiment of the present invention,

FIG. 4, shows a graph: of colour space in a projection system, and

FIG. 5, shows the illumination window according to the preferred embodiment of the present invention utilising a series of filters.

### DETAILED DESCRIPTION OF PREFERRED EMBODIMENTS

In the following description of the various embodiments, reference is made to the accompanying drawing which form a part hereof, and in which are shown by way of illustration various embodiments in which the invention may be practiced. It is to be understood that other embodiments may be utilized and structural and functional modifications may be made without departing from the scope of the present invention.

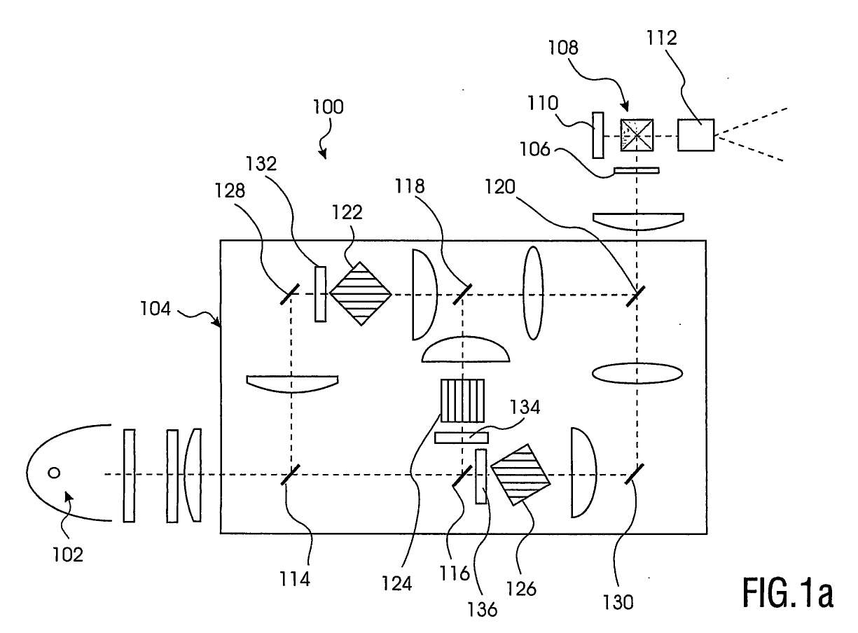

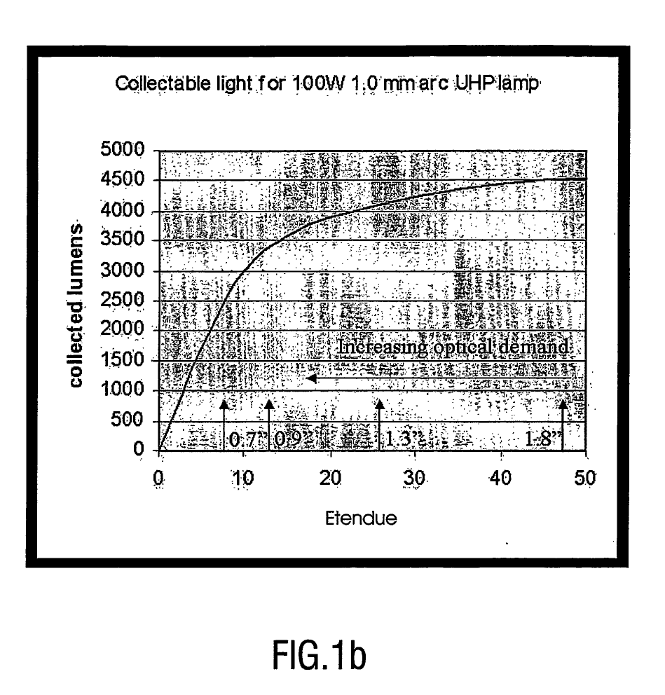

FIG. 1 shows, as described above, a projection system 100, which may be a scrolling colour liquid crystal on silicon(LcoS) projection system, and shows the rotating prisms 122, 124, 126 for generating a scrolling colour effect on an illumination window. By positioning slits 132, 134 and 136 before each rotating prisms 122, 124 and 126 sharp colour bars are obtained on the display panel. Each slit 132, 134 and 136 is illuminated by its corresponding colour red, green or blue and is imaged on a display panel through the prisms 122, 124 and 126.

A display panel in this context should be construed as a light valve means or light modulating means such as a transmissive liquid crystal display, a reflective liquid crystal on silicon or a reflective Micro Electrical Mechanical based display such as a DMD panel.

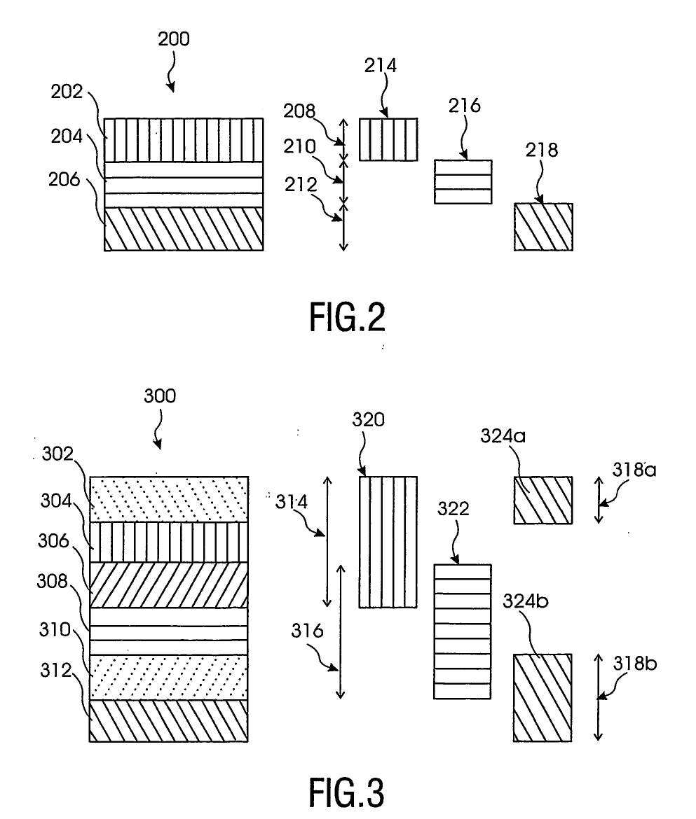

FIG. 2, shows an illumination window 200 as obtained by prior art system and projected on to a display panel. The illumination window 200 has red 202, green 204 and blue 206 scrolling colour bars. The widths 208, 210, and 212 of the respective slits 214, 216, and 218 determines the widths of the colour bars 202, 204, and 206. The widths 208, 210, and 212 are selected so as to generate exactly three colour bars 202, 204, and 206 on the display panel. Coloured images are generated by writing each line in the display panel with new colour information as soon as a new colour starts to appear on the corresponding row in the display panel.

FIG. 3, shows an illumination window 300 projected on to a display panel, which illumination window 300 has six scrolling colour bars, namely a purple 302, a red 304, a yellow 306, a green 308, a cyan 310, and a blue 312 colour bar. The six colour bars are generated by extending the widths 208, 210, and 212, shown in FIG. 3 as extended widths 314, 316, 318a and 318b. Hence slits 320, 322, and 324 (where slit 324 is shown as two separate parts 324a and 324b) are wider than slits 214, 216, and 218, shown in FIG. 2, so that the red, green and blue colour bars 304, 308 and 312 partly overlap each other. The overlaps generate mixed colour bars namely purple 302, yellow 306 and cyan 310.

Each pixel of the display panel is driven sequentially relative to time so that the total amount of light per colour balances the colour as required by each pixel. Since the red, green and blue colour bars 304, 308 and 312 cover a greater area of the display panel, the throughput of the light path is increased and a greater amount of light from the projector light source is collected and guided through the projection system thereby achieving a higher brightness. In case each of the red, green and blue colour bars 304, 308 and 312 covers 50% of the display area, a 0.7″ 3-panel projection system will use the same amount of collected lumens from the light source than a \sqrt{2}* 0.7=0.99″. This means that a projection system according to the present invention will approximately supply the same brightness with a 0.99″ display panel that a scrolling colour projection system using a 1.2″ display panel according to the prior art.

According to the preferred embodiment of the present invention one of the slits 320, 322 and/or 324 allows a wider wavelength range to be channelled through to associated prisms 122, 124, and/or 126.

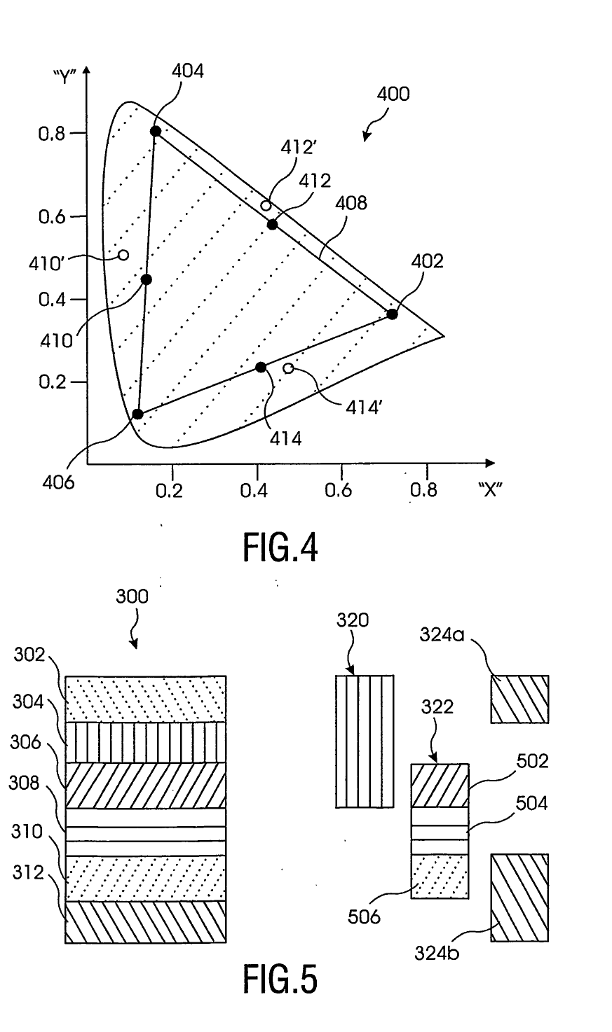

FIG. 4, shows a graph of colour space designated in entirety by reference numeral 400 in a projection system. The first set of colours (primaries red 402, green 404 and blue 406) defines a complete span 408 of colour space of the projection system. The second set of colours (primaries cyan 410, yellow 412 and purple 414) comprises primaries which generate high brightness values. The second set of colours are generated by combining the first set of colours, that is cyan=green+blue; yellow=red+green; and purple=blue+red.

In prior art projection systems the full spectrum of the light source is generally not effectively utilised. Especially the spectral parts around the 500 nm (490 to 510 nm) and around the 600 nm (590 to 610 nm) is filtered away since these parts de-saturate the primary red, green and blue colours. However, since the projection systems according to the present invention generates mixed colour bars 302, 306, and 310(purple, yellow, and cyan), the wavelength ranges around 500 nm and around 600 nm may now be utilised in the cyan and yellow colour bars 306, 310. Hence in the preferred embodiment the full 480 to 590 nm wavelength range is channelled through the green prism, the green colour de-saturates resulting in a green colour point with a low “y” value in the “x”-“y” colour space 400. By adding filters, shown in FIG. 5 as reference numerals 502, 504, and 506, before the green prism a compensation of the low “y” value is achieved. Thus a 490 to 580 nm wavelength range filtering is added for the Green colour bar 308, pushing the “y”-value of the green primary 404 back to its desired value. A 480 to 510 nm wavelength range filtering is added for the yellow colour bar 306 and a 560 to 590 nm wavelength range filtering is added for the cyan colour bar 310. The brightness of the yellow and cyan colour bars 306 and 310 is increased, while their colour points, shown in FIG. 4 as reference numerals 410′, 412′, 414′, are pushed outside the old colour space 400 as defined by the red 402, green 404 and blue 406 primary colours.

According to an alternative embodiment of the present invention the cyan and yellow filter in the green slit, which filters also transmit parts of the complementary colours. That is, the cyan filter transmits part of the yellow and the yellow filter transmits part of the cyan. This pushes the points 410′, 412′ and 414′ back to original points 410, 412 and 414, while the 480 to 510 mn and 560 to 590 nm wavelength ranges increase the brightness.

In a further alternative embodiment of the present invention the system comprises wave guides for guiding the colours towards the predetermined positions in front of the prisms (122, 124 and 126).

Where the preferred embodiment in this disclosure uses rotating prisms as scrolling means for sweeping colours over the display panel, the invention may in alternative embodiments comprise different types of scrolling means such as spinning wheels, rotating drums, rotating polygan mirrors, MEM based scanners, LCD based scanners and more.

1. A system for displaying modulated light comprising a light valve (110) for modulating light originating from a light source unit (102), and comprising separating means (104) for splitting said light from said light source unit (102) into at least two colour bars (304, 308, 312) and scrolling means (122, 124, 126) for sweeping said at least two colour bars (304, 308, 312) over said light valve (110), said system characterized in that said scrolling means (122, 126, 126) comprising communication means (132, 134, 136) adapted to communicate said at least two colour bars (304, 306, 308) partly overlapping thereby generating at least one further colour bar (302, 306, 310) for said light valve (110).

2. A system according to claim 1, wherein said light valve (110) comprising a panel having a plurality of pixels, which panel is adapted to received said sweeping at least two colour bars (304, 308, 312), and wherein said system further comprising panel addressing means adapted to write information to said plurality of pixels when receiving a new colour bar (302, 304, 306, 308, 310, 312).

3. A system according to claim 2 further comprising an electronic colour decoder circuit adapted to convert a colour image signal to driving colour signal for driving each of said plurality of pixels and for generating a colour image in accordance with a combination of said driving signal and said colour bars (302, 304, 306, 308, 310, 312).

4. A system according to claim 1, wherein said at least two colour bars comprising a red (304), a green (308) and a blue (312) colour bar and wherein said communication means (132, 134, 136) is adapted to overlap said red and blue colour bars (304, 312) to generate a purple colour bar (302) for said light valve (110), overlap said red and green colour bars (304, 308) to generate a yellow colour bar (306) for said light valve (110), and overlap said green and blue colour bars (308, 312) to generate a cyan colour bar (310) for said light valve (110).

5. A system according to claim 4 further comprising an optical component positioned in light path from said light source unit (102) to said light valve (110) and operable to enable spectral parts of the light from the light source unit (102) in the spectrum at 500 nm or 600 nm to hit said cyan colour bar (310) and said yellow colour bar (306).

6. A system according to claim 1, wherein said separating means (104) comprising a first, a second and a third rotating element, such as a prism (122, 124, 126), a wheel, a drum, a polygon mirror, a vibrating element or any combination thereof, for generating said red, green and blue colour bars (304, 308, 312).

7. A system according to claim 6, wherein said rotating element comprising a micro electromechanical element.

8. A system according to claim 1, wherein said light valve (110) comprising a LCD based light modulating element.

9. A system according to claim 6, wherein said communication means comprising slits (132, 134, 136) positioned before said first, second and third rotating element (122, 124, 126) and each having a width (314, 316, 318) defining overlap between said red, green and blue colour bars (304, 308, 312).

10. A system according to claim 1, wherein said separating means (104) further comprises dichroic colour filters (114, 116, 118, 120), and reflecting mirrors (128, 130).

11. A system according to claim 6 further comprising a controller for controlling phase and rotation of said rotating elements (122, 124 and 126) so as to project and scroll on said colour bars (302, 304, 306, 308, 310, 312) on to said light valve (110) at specific times in relation to said colour image signal.

12. A system according to claim 4 further comprising filter means (502, 504, 506) for filtering of said red, green or blue colour bar (304, 308, 312).

13. A system according to claim 4 further comprising filter means (502, 504, 506) for filtering of said green colour bar (308).

14. A system according to claim 13, wherein said filter means (502, 504, 506) comprising a first filter for enabling said yellow colour bar (306), a second filter for enabling said green colour bar (308), and a third filter for enabling said cyan colour bar (310).

15. A system according to claim 14, wherein said first filter substantially passes light having a wavelength in the range 560 to 590 nm, said second filter substantially passes light having a wavelength in the range 510 to 560 nm, and said third filter substantially passes light having a wavelength in the range 480 to 510 nm.

16. A system according to claim 15, wherein said first filter further passes parts of light having a wavelength in the range between 480 to 510 nm, and said third filter further passes parts of light having a wavelength in the range between 560 to 590 nm.

17. A system according to claim 13, wherein said filter means (502, 504, 506) comprises a first wave guide for enabling said yellow colour bar (306), a second wave guide for enabling said green colour bar (308), and a third wave guide for enabling said cyan colour bar (310).

18. A system according to claim 17, wherein said first wave guide substantially passes light having a wavelength in the range 560 to 590 nm, said second wave guide substantially passes light having a wavelength in the range 510 to 560 nm, and said third wave guide substantially passes light having a wavelength in the range 480 to 510 nm.

19. A system according to claim 18, wherein said first wave guide further passes parts of light having a wavelength in the range between 480 to 510 nm, and said third wave guide further passes parts of light having a wavelength in the range between 560 to 590 nm.
